(19) United States
(12) Patent Application Publication
(10) Pub. No.: US 2007/0177831 A1
(43) Pub. Date: Aug. 2, 2007

(54) Fluid bearing device and manufacturing method thereof

(76) Inventor: Katsuo Shibahara, Mie-ken (JP)

Correspondence Address: ARENT FOX PLLC, 1050 CONNECTICUT AVENUE, N.W., SUITE 400, WASHINGTON, DC, 20036, US

(21) Appl. No.: 10/562,880

(22) PCT Filed: Aug. 18, 2004
(86) PCT No.: PCT/JP04/12148

§ 371 Date: Apr. 28, 2006

(30) Foreign Application Priority Data
Aug. 18, 2003 (JP) 2003-294528

(51) Int. Cl. H02K 5/16; F16C 32/06

(52) U.S. Cl. 384/107; 310/90; 384/112

(57) ABSTRACT

A molten resin P is filled into a cavity 17 through a film gate 17a provided a ring shape in a position corresponding with an outer peripheral edge of the outside surface 7a2 of the seal portion 7a. The molded product removed from the molding die is completed by removing the residual resin gate portion 7d. A gate removal portion 7d1 formed by removing the resin gate portion appears as a narrow ring shape at the outer peripheral edge of the outside surface 7a2 of the seal portion 7a.

### TECHNICAL FIELD

The present invention relates to a fluid bearing device which supports a rotating member in a non-contact manner via a lubricating oil film that is generated within a radial bearing gap, as well as a method of manufacturing such a fluid bearing device. This bearing device is ideal for use in information-processing equipment, including the spindle motors for magnetic disk devices such as HDD and FDD, optical disk devices for CD-ROM, CD-R/RW, DVD-ROM/RAM, etc. and magneto-optical disk devices for MD, MO, etc., the polygon scanner motors in laser beam printers (LBP), or as small-scale motors for electrical equipment such as axial flow fans.

### BACKGROUND ART

In each of the motor types described above, in addition to high rotational precision, other sought after performance factors include increased speed, lower costs, and lower noise generation. One of the structural elements that determines the performance of the motor in terms of these factors is the bearing that supports the spindle of the motor. In recent years, fluid bearing devices, which display superior results for the above performance factors, have been investigated, and in some cases used in actual applications.

These fluid bearing devices can be broadly classified into dynamic bearings, which are equipped with dynamic pressure generating means for generating a dynamic pressure in the lubricating oil within the bearing gap, and so-called cylindrical bearings (bearings in which the bearing surface is a complete round shape) which contain no dynamic pressure generating means.

For example, a fluid bearing device incorporated within the spindle motor of a disk drive device for HDD or the like is provided with a radial bearing portion, which supports the shaft member in a non-contact manner in the radial direction in a manner that enables free rotation of the shaft, and a thrust bearing portion, which supports the shaft member in a non-contact manner in the thrust direction in a manner that enables free rotation of the shaft. The radial bearing portion utilizes a dynamic bearing in which grooves for generating the dynamic pressure (dynamic-pressure generating grooves) are provided in either the inner peripheral surface of the bearing sleeve or the outer peripheral surface of the shaft member. The thrust bearing portion utilizes a dynamic bearing in which, for example, dynamic-pressure generating grooves are provided in either both end surfaces of a flange portion of the shaft member, or in the surfaces opposing these end surfaces (such as the end surfaces of the bearing sleeve, the end surfaces of a thrust member that is fixed to the housing, or the inside bottom surface of the bottom portion of the housing) (for examples, see the Japanese Patent Laid-Open Publications No. 2002-61637 and 2002-61641). Alternatively, bearings in which one end surface of the shaft member is supported through contact with a thrust plate (so-called pivot bearings) may also be used as the thrust bearing portion (for an example, see the Japanese Patent Laid-Open Publication No. 1999-191943).

Normally, the bearing sleeve is fixed to a predetermined position on the inner periphery of the housing, and a seal member is often disposed within the open portion of the housing to prevent external leakage of the lubricating oil used to fill the internal space within the housing (see the Japanese Patent Laid-Open Publication No. 2002-61637). Alternatively, the seal portion may also be formed as an integrated part at the open portion of the housing (see the Japanese Patent Laid-Open Publication No. 2002-61641).

In addition, in order to prevent leakage of the lubricating oil, an oil repellent may also be applied to the outer peripheral surface of the shaft member, the outside surface of the housing that connects through to the radial bearing gap, and the inner peripheral surface of the seal member (for examples, see the Japanese Utility Model Laid-Open Publication No. 1994-35660 and Japanese Patent Laid-Open Publication No. 1996-49723patent).

This type of fluid bearing device comprises components including a housing, a bearing sleeve, a shaft member, a thrust member, and a seal member, and in order to ensure the high level of bearing performance required to keep pace with the rapidly improving performance of information-processing equipment, strenuous efforts are being made to improve the processing precision and assembly precision of each of these components. On the other hand, with the trend towards lower cost information-processing equipment, the demand for cost reductions of these types of fluid bearing devices is also growing stronger.

One possible technique for achieving a cost reduction for the types of fluid bearing devices described above involves forming the housing by injection molding of a resin material. However, depending on the configuration of the injection molding, and particularly on the shape and position of the gate through which the molten resin is injected into the internal cavity, the required molding precision for the housing may not be achievable. Furthermore, the gate removal portion, which is formed by removal (by mechanical processing) of a resin gate portion that is produced following the injection molding process, is formed at the surface where oil repellency is required, and even if an oil repellent is applied to this surface, a satisfactory oil repellent effect may still be unattainable.

For example in a case such as that shown in FIG. 4(a), wherein a housing 7′ comprising a cylindrical side portion 7b′, and a seal portion 7a′ which forms a single, continuous integrated unit with the side portion 7b′ and extends radially inward from one end of the side portion 7b′ is formed by injection molding of a resin material, typically, as shown in FIG. 4(b), a method is employed in which a disk gate 17a′ is provided in a central portion at one end of the molding die cavity 17′, and a molten resin P is then injected into the cavity 17′ through this disk gate 17a′. However, in this molding method, the molded product produced by molding comprises a resin gate portion 7d′ that is connected to the inner peripheral edge of the outside surface 7a2′ of the seal portion 7a′, as shown in FIG. 4(c) (section A). Accordingly, following molding, a removal process (mechanical processing) is conducted to remove the resin gate portion 7d′ along either the line X or the line Y shown in FIG. 4(c). As a result, if a removal process is performed in which the resin gate portion 7d′ is removed along the line X, then a gate removal portion (a mechanically processed surface) is formed on the inner peripheral edge of the outside surface 7a2′ of the seal portion 7a′, whereas if a removal process is performed in which the resin gate portion 7d′ is removed along the line Y, then a gate removal portion (a mechanically processed surface) is formed across the entire outside surface 7a2′ of the seal portion 7a′.

Typically, the oil repellency of an oil repellent is significantly affected by the surface state of the base material to which it is applied, and the oil repellency on a mechanically processed resin surface is inferior to that observed on a molded surface. On the other hand, the area of the outside surface 7a2′ of the seal portion 7a′ that most requires oil repellency is the inner peripheral area nearest to the inner peripheral surface 7a1′ which forms the seal surface. However, in the molding method described above, a gate removal portion formed by removing the resin gate portion 7d′ is formed at the inner peripheral area of the outside surface 7a2′ regardless of whether the removal process is conducted along the line X or the line Y, and as a result, even if an oil repellent is applied to the outside surface 7a2′, a satisfactory level of oil repellency is often unattainable.

### DISCLOSURE OF THE INVENTION

An object of the present invention is to provide a fluid bearing device which provides a reduction in the manufacturing costs of the housing used in this type of fluid bearing device, and also enables a more efficient assembly process, thereby offering even lower costs.

Another object of the present invention is to improve the molding precision of housings produced by resin injection molding.

Yet another object of the present invention is to resolve the problems of reduced oil repellency at the gate removal portion within housings produced by resin injection molding.

In order to achieve the above objects, the present invention provides a fluid bearing device comprising a housing, a bearing sleeve disposed inside the housing, a shaft member inserted along an inner peripheral surface of the bearing sleeve, and a radial bearing portion which supports the shaft member in a non-contact manner in a radial direction via a lubricating oil film that is generated within a radial bearing gap between the inner peripheral surface of the bearing sleeve and an outer peripheral surface of the shaft member, wherein the housing is formed by injection molding of a resin material, and comprises a cylindrical side portion and a seal portion which forms a continuous integrated unit with the side portion and extends radially inward from one end of the side portion, the seal portion comprises an inner peripheral surface which forms a sealing space with an opposing outer peripheral surface of the shaft member, and an outside surface which is positioned adjacent to the inner peripheral surface, and an outer peripheral edge of this outside surface comprises a gate removal portion formed by removing a resin gate portion.

By forming the housing by injection molding of a resin material, not only can the housing be manufactured at a lower cost than a metal housing produced by a mechanical process such as turning, but a comparatively higher level of precision can be achieved than a metal housing produced by press working. Furthermore, by forming the seal portion as an integrated section of the housing, both the number of components and the number of assembly steps can be reduced in comparison with the case where a separate seal member is secured inside the housing.

Furthermore, the housing also comprises a gate removal portion formed by removing the resin gate portion at the outer peripheral edge of the outside surface of the seal portion. In other words, with the exception of the outer peripheral edge where the gate removal portion is located, the outside surface of the seal portion is a molded surface, and by applying an oil repellent to an outside surface with this type of surface state, a satisfactory oil repellency effect can be achieved, enabling effective prevention of any leakage of the lubricating oil from inside the housing.

Depending on the shape of the gate in the molding die, the gate removal portion may appear as a single point, a plurality of points, or a ring shape, at the outer peripheral edge of the outside surface of the seal portion. However, from the viewpoints of ensuring a uniform filling of the mold cavity with molten resin, and improving the molding precision of the housing, the gate is preferably formed in a ring shape, meaning the gate removal portion also appears as a ring shape. Accordingly, the gate removal portion is preferably a ring shape.

There are no particular restrictions on the resin used to form the housing provided a thermoplastic resin is used, and examples of suitable non-crystalline resins include polysulfones (PSF), polyethersulfones (PES), polyphenylsulfones (PPSF), and polyetherimides (PEI). Furthermore, examples of suitable crystalline resins include liquid crystal polymers (LCP), polyetheretherketones (PEEK), polybutylene terephthalate (PBT), and polyphenylene sulfides (PPS).

Furthermore, there are also no particular restrictions on the addition of fillers to the above resin, and examples of suitable fillers include fibrous fillers such as glass fiber, whisker fillers such as potassium titanate, scaly fillers such as mica, and fibrous or powdered conductive fillers such as carbon fiber, carbon black, graphite, carbon nanomaterials, and metal powders.

For example, in a fluid bearing device incorporated within a spindle motor for a disk drive device for HDD or the like, the housing may require a level of conductivity, to enable static electricity generated by friction between the disk such as the magnetic disk and air to be dissipated to ground. In such cases, by adding a conductive filler described above to the resin used for forming the housing, conductivity can be imparted to the housing.

From the viewpoints of achieving a high level of conductivity, favorable dispersibility within the resin matrix, favorable abrasion resistance, and a low level of out-gas, carbon nanomaterials are preferred as the aforementioned conductive filler. Of the available carbon nanomaterials, carbon nanofiber is preferred. These carbon nanofibers include so-called “carbon nanotubes” with a diameter of 40 to 50 nm or less.

Furthermore in order to achieve the above objects the present invention also provides a method of manufacturing a fluid bearing device comprising a housing, a bearing sleeve disposed inside the housing, a shaft member inserted along an inner peripheral surface of the bearing sleeve, and a radial bearing portion which supports the shaft member in a non-contact manner in a radial direction via a lubricating oil film that is generated within a radial bearing gap between the inner peripheral surface of the bearing sleeve and an outer peripheral surface of the shaft member, Here, the method comprises a housing molding step of molding the housing by injection molding of a resin material, the housing comprising a cylindrical side portion, and a seal portion which forms a continuous integrated unit with the side portion and extends radially inward from one end of the side portion, wherein the seal portion comprises an inner peripheral surface which forms a sealing space with an opposing outer peripheral surface of the shaft member, and an outside surface which is positioned adjacent to the inner peripheral surface, and in the housing molding step, a ring shaped film gate is provided in a position corresponding with an outer peripheral edge of the outside surface of the seal portion, and a molten resin is injected through this film gate into a cavity used for molding the housing.

In the housing molding step, by providing a ring shaped film gate in a position corresponding with the outer peripheral edge of the outside surface of the seal portion, and injecting a molten resin through this film gate into the cavity used for molding the housing, the molten resin fills the cavity uniformly in both a circumferential direction and an axial direction, enabling the production of a housing with a high degree of dimensional precision.

In this description, the film gate refers to a gate with a narrow gate width, and although the gate width varies depending on factors such as the physical properties of the resin material and the injection molding conditions, it is typically from 0.2 mm to 0.8 mm. Because this type of film gate is provided in a position corresponding with the outer peripheral edge of the outside surface of the seal portion, the molded product following molding is shaped such that a film-like (thin) resin gate portion is connected in a ring shaped manner to the outer peripheral edge of the outside surface of the seal portion. In many cases this film-like resin gate portion fragments automatically during the operation of opening the molding die, so that when the molded product is removed from the molding die, a fragmented section of the resin gate portion remains at the outer peripheral edge of the outside surface of the seal portion. The gate removal portion formed by removing this type of residual resin gate portion appears as a narrow ring shape at the outer peripheral edge of the outside surface of the seal portion.

According to the present invention, a fluid bearing device can be provided which enables a reduction in the manufacturing costs of the housing, and also enables a more efficient assembly process, thereby offering even lower costs.

Furthermore, according to the present invention, the molding precision of a housing produced by resin injection molding can be improved.

In addition, according to the present invention, the problem of a reduction in oil repellency at the gate removal portion of a housing produced by resin injection molding can be resolved.

### BRIEF DESCRIPTION OF THE DRAWINGS

FIG. 1 is a cross-sectional view of a spindle motor for information-processing equipment, using a fluid bearing device according to the present invention;

FIG. 2 is a cross-sectional view showing an embodiment of a fluid bearing device according to the present invention;

FIG. 3(a) and FIG. 3(b) are a cross-sectional view showing a schematic illustration of a molding step for a housing; and

FIG. 4(a), FIG. 4(b), and FIG. 4(c) are a cross-sectional view showing a schematic illustration of a molding step for a conventional housing.

### BEST MODE FOR CARRYING OUT THE INVENTION

As follows is a description of embodiments of the present invention.

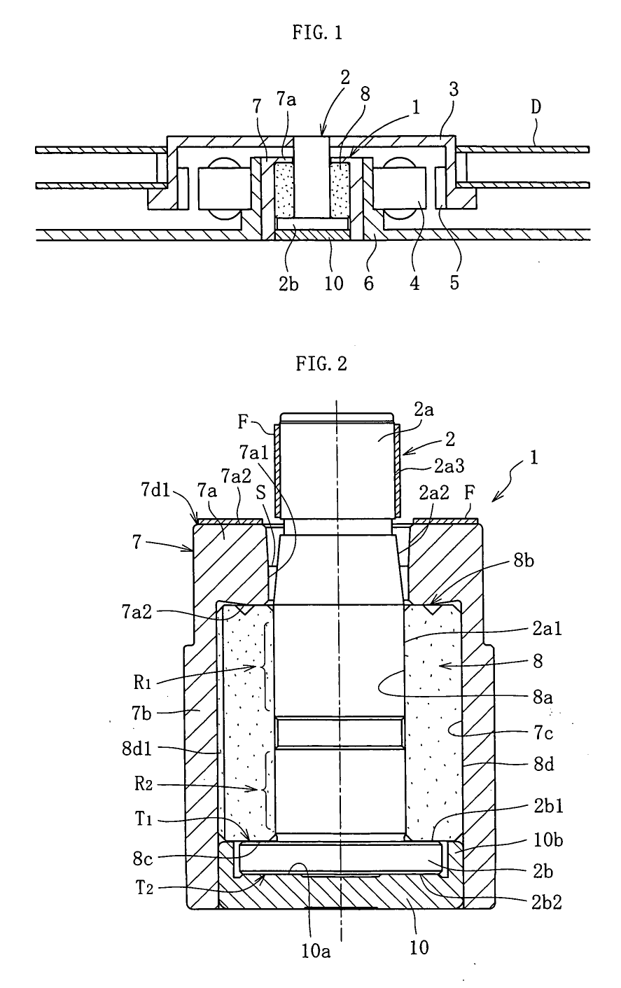

FIG. 1 is a schematic illustration showing one possible construction of a spindle motor for information-processing equipment incorporating a fluid bearing device (a fluid dynamic bearing device) 1 according to this embodiment. This spindle motor is used in a disk drive device for HDD or the like, and comprises a fluid bearing device 1 which supports a shaft member 2 in a freely rotatable, non-contact manner, a rotor (disk hub) 3 which is mounted onto the shaft member 2, and a stator 4 and a rotor magnet 5 which oppose one another across a gap in the radial direction, for example. The stator 4 is attached to the outer periphery of a bracket 6, and the rotor magnet 5 is attached to the inner periphery of the disk hub 3. A housing 7 for the fluid bearing device 1 is mounted to the inner periphery of the bracket 6. Either one disk or a plurality of disks D such as magnetic disks are supported by the disk hub 3. When current passes through the stator 4, the rotor magnet 5 begins to rotate as a result of the electromagnetic force between the stator 4 and the rotor magnet 5, thereby causing the disk hub 3 and the shaft member 2 to also rotate in a unified manner.

FIG. 2 shows the fluid bearing device 1. This fluid bearing device 1 comprises the housing 7, a bearing sleeve 8 and a thrust member 10 secured to this housing 7, and the shaft member 2 as the primary structural components.

A first radial bearing portion R1 and a second radial bearing portion R2 are provided between an inner peripheral surface 8a of the bearing sleeve 8 and an outer peripheral surface 2a1 of the shaft portion 2a of the shaft member 2, with the two bearing portions separated along the axial direction. Furthermore, a first thrust bearing portion T1 is provided between a lower end surface 8c of the bearing sleeve 8 and an upper end surface 2b1 of a flange portion 2b of the shaft member 2, and a second thrust bearing portion T2 is provided between an end surface 10a of the thrust member 10 and a lower end surface 2b2 of the flange portion 2b. For the sake of ease of description, the side where the thrust member 10 is positioned is termed the lower side and the side opposite to the thrust member 10 is termed the upper side.

The housing 7 is formed, for example, by injection molding of a resin material formed by combining 2 to 30 vol % of a conductive filler such as carbon nanotubes or conductive carbon with a crystalline resin such as a liquid crystal polymer (LCP), and comprises a circular cylindrical side portion 7b, and a ring shaped seal portion 7a which forms a single, continuous integrated unit with the side portion 7b and extends radially inward from the top end of the side portion 7b. An inner peripheral surface 7a1 of the seal portion 7a forms a predetermined sealing space S with an opposing outer peripheral surface 2a1 of the shaft portion 2a, such as a tapered surface 2a2 formed on the outer peripheral surface 2a1. The tapered surface 2a2 of the shaft portion 2a gradually narrows towards the top (towards the exterior of the housing 7), and functions as a centrifugal seal on rotation of the shaft member 2.

The shaft member 2 is formed of a metal material such as stainless steel, and comprises the shaft portion 2a, and the flange portion 2b, which is provided at the bottom end of the shaft portion 2a, either as an integrated part of the shaft member or as a separate body.

The bearing sleeve 8 is formed in a circular cylindrical shape, from a porous body formed of a sintered metal, and particularly a sintered metal containing copper as a primary component, and is secured at a predetermined position on the inner peripheral surface 7c of the housing 7.

The radial bearing surfaces, namely the first radial bearing portion R1 and the second radial bearing portion R2, are provided as an upper and lower region on the inner peripheral surface 8a of the bearing sleeve 8 formed of the sintered metal, with the two regions separated along the axial direction, and herringbone shaped dynamic-pressure generating grooves are formed within these two regions.

Either spiral shaped or herringbone shaped dynamic-pressure generating grooves are also formed in the lower end surface 8c of the bearing sleeve 8, which functions as the thrust bearing surface for the first thrust bearing portion T1.

The thrust member 10 is formed of a resin material or a metal material such as brass, and is secured to the lower end of the inner peripheral surface 7c of the housing 7. In this embodiment, the thrust member 10 also comprises an integrated, ring shaped contact portion 10b, which extends upwards from the outer peripheral edge of the end surface 10a. An upper end surface of this contact portion 10b contacts the lower end surface 8c of the bearing sleeve 8, and the inner peripheral surface of the contact portion 10b opposes the outer peripheral surface of the flange portion 2b across a gap. Herringbone shaped or spiral shaped dynamic-pressure generating grooves are also formed in the end surface 10a of the thrust member 10, which functions as the thrust bearing surface for the second thrust bearing portion T2. By controlling the axial dimensions of both the contact portion 10b of the thrust member 10 and the flange portion 2b, the thrust bearing gaps of the first thrust bearing portion T1 and the second thrust bearing portion T2 can be set with good precision.

The internal space within the housing 7 sealed by the seal portion 7a, including the internal pores within the bearing sleeve 8, is filled with a lubricating oil. The surface of the lubricating oil is maintained within the sealing space S. Furthermore, an oil repellent F is applied to the outside surface 7a2 adjacent to the inner peripheral surface 7a1 of the seal portion 7a. In addition, the oil repellent F is also applied to the outer peripheral surface 2a3 of the shaft member 2 that extends through the seal portion 7a and protrudes outside the housing 7.

When the shaft member 2 rotates, the regions (namely, upper and lower regions) that function as the radial bearing surfaces for the inner peripheral surface 8a of the bearing sleeve 8 each oppose the outer peripheral surface 2a1 of the shaft portion 2a across a radial bearing gap. Furthermore, the region that forms the thrust bearing surface on the lower end surface 8c of the bearing sleeve 8 opposes the upper end surface 2b1 of the flange portion 2b across a thrust bearing gap, and the region that forms the thrust bearing surface on the end surface 10a of the thrust member 10 opposes the lower end surface 2b2 of the flange portion 2b across a thrust bearing gap. Then, as the shaft member 2 rotates, a lubricating oil dynamic pressure is generated within the above radial bearing gap, and the shaft portion 2a of the shaft member 2 is supported in a freely rotatable, non-contact manner in the radial direction by the lubricating oil film that is formed within the radial bearing gap. Accordingly, the first radial bearing portion R1 and the second radial bearing portion R2 are formed, which support the shaft member 2 in a non-contact manner in the radial direction, in a manner that enables free rotation. At the same time, a lubricating oil dynamic pressure is also generated within the above thrust bearing gaps, and the flange portion 2b of the shaft member 2 is supported in a freely rotatable, non-contact manner in both thrust directions by lubricating oil films that are formed within these thrust bearing gaps. Accordingly, the first thrust bearing portion T1 and the second thrust bearing portion T2 are formed, which support the shaft member 2 in a non-contact manner in the thrust direction, in a manner that enables free rotation.

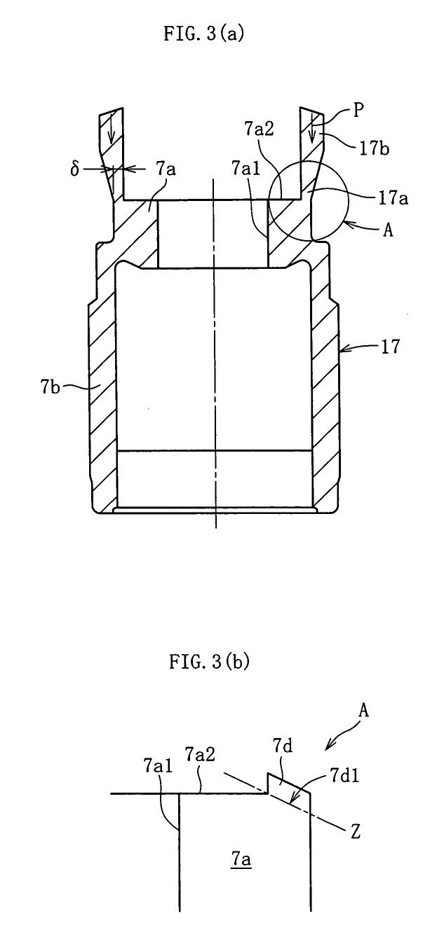

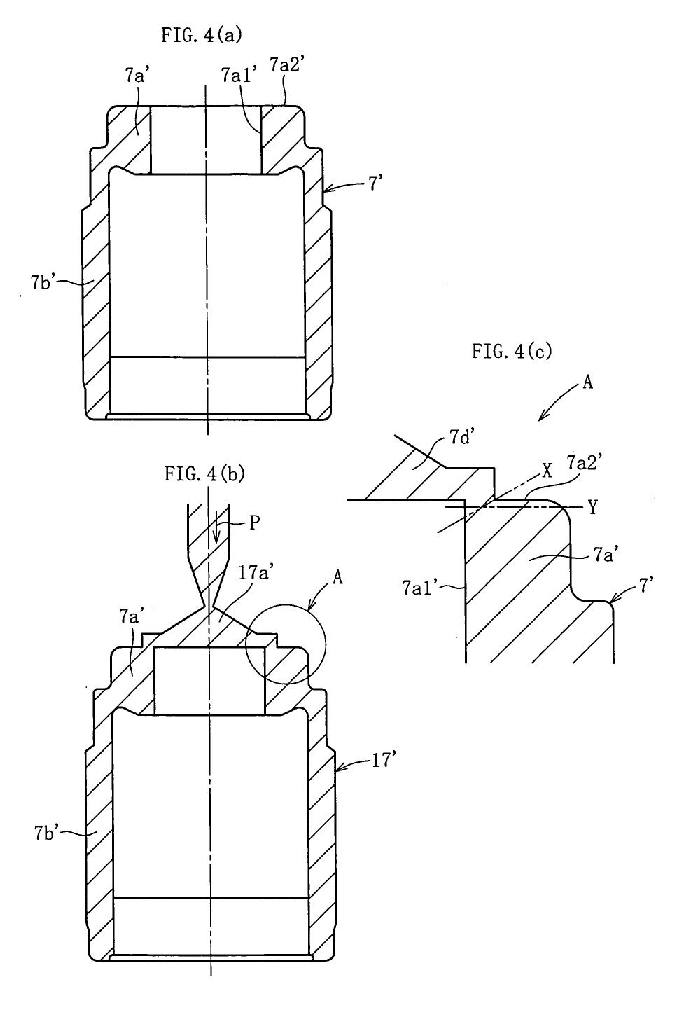

FIG. 3 shows a schematic illustration of a molding step for the housing 7 in a fluid bearing device 1 described above. A molding die comprising a stationary mold and a movable mold is provided with a runner 17b, a film gate 17a, and a cavity 17. The film gate 17a is formed in a ring shape in a position corresponding with the outer peripheral edge of the outside surface 7a2 of the seal portion 7a, and the gate width 6 is set to 0.3 mm, for example.

Molten resin P ejected from the nozzle of an injection molding device, which is not shown in the figure, passes through the runner 17b and the film gate 17a of the molding die, and fills the inside of the cavity 17. By filling the cavity 17 with the molten resin P in this manner, through the ring shaped film gate 17a provided in a position corresponding with the outer peripheral edge of the outside surface 7a2 of the seal portion 7a, the molten resin P fills the cavity 17 uniformly in both a circumferential direction and an axial direction, enabling the production of a housing 7 with a high degree of dimensional precision.

Once the molten resin P that has filled the inside of the cavity 17 has cooled and hardened, the movable mold is moved and the molding die is opened. Because the film gate 17a is provided in a position corresponding with the outer peripheral edge of the outside surface 7a2 of the seal portion 7a, the molded product prior to opening of the die is shaped such that a film-like (thin) resin gate portion is connected in a ring shaped manner to the outer peripheral edge of the outside surface 7a2 of the seal portion 7a, but this resin gate portion fragments automatically during the operation of opening the molding die, so that when the molded product is removed from the molding die, a fragmented section of the resin gate portion 7d remains at the outer peripheral edge of the outside surface 7a2 of the seal portion 7a, as shown in FIG. 3(b). The housing 7 is completed by subsequently removing (by mechanical processing) this residual resin gate portion 7d along a line Z shown in the figure.

In the completed housing 7, a gate removal portion 7d1 formed by removing the resin gate portion 7d appears as a narrow ring shape at the outer peripheral edge of the outside surface 7a2 of the seal portion 7a. Accordingly, with the exception of the outer peripheral edge where the gate removal portion 7d1 is located, the outside surface 7a2 of the seal portion 7a is a molded surface as is, and by applying an oil repellent F to the outside surface 7a2 with this type of surface state, a satisfactory oil repellency effect can be achieved, enabling effective prevention of any leakage of the lubricating oil from inside the housing 7.

The present invention can be applied to both fluid bearing devices employing a so-called pivot bearing as the thrust bearing portion, and fluid bearing devices employing so-called cylindrical bearings as the radial bearing portion.

1. A fluid bearing device comprising:
a housing;
a bearing sleeve disposed inside the housing;
a shaft member inserted along an inner peripheral surface of the bearing sleeve; and
a radial bearing portion which supports the shaft member in a non-contact manner in a radial direction via a lubricating oil film that is generated within a radial bearing gap between the inner peripheral surface of the bearing sleeve and an outer peripheral surface of the shaft member, wherein
the housing is formed by injection molding of a resin material, and comprises a cylindrical side portion and a seal portion which forms a continuous integrated unit with the side portion and extends radially inward from one end of the side portion,
the seal portion comprises an inner peripheral surface which forms a sealing space with an opposing outer peripheral surface of the shaft member, and an outside surface which is positioned adjacent to the inner peripheral surface, and
an outer peripheral edge of the outside surface comprises a gate removal portion formed by removing a resin gate portion.

2. The fluid bearing device according to claim 1, wherein
the gate removal portion is formed in a ring shape.

3. The fluid bearing device according to claim 1 or 2, wherein
the outside surface of the seal portion is applied with an oil repellent.

4. A method of manufacturing a fluid bearing device including a housing, a bearing sleeve disposed inside the housing, a shaft member inserted along an inner peripheral surface of the bearing sleeve, and a radial bearing portion which supports the shaft member in a non-contact manner in a radial direction via a lubricating oil film that is generated within a radial bearing gap between the inner peripheral surface of the bearing sleeve and an outer peripheral surface of the shaft member,
the method comprising a housing molding step of molding the housing by injection molding of a resin material, the housing having a shape comprising a cylindrical side portion, and a seal portion which forms a continuous integrated unit with the side portion and extends radially inward from one end of the side portion, wherein
the seal portion comprises an inner peripheral surface which forms a sealing space with an opposing outer peripheral surface of the shaft member, and an outside surface which is positioned adjacent to the inner peripheral surface, and
in the housing molding step, a ring shaped film gate is provided in a position corresponding with an outer peripheral edge of the outside surface of the seal portion, and a molten resin is injected through the film gate into a cavity used for molding the housing.
